(19) United States
(12) Patent Application Publication
(10) Pub. No.: US 2014/0280526 A1
(43) Pub. Date: Sep. 18, 2014

(54) Method of Social Networking Using a Defined Geo-Fence and Check-In Feature

(71) Applicant: Sergio Filho, Salvador (BR)

(72) Inventor: Sergio Filho, Salvador (BR)

(21) Appl. No.: 13/796,655

(22) Filed: Mar. 12, 2013

(51) Int. Cl. H04L 29/08

(52) U.S. Cl. CPC H04L 67/22
USPC 709/204

(57) ABSTRACT

A method and system for creating and operating a localized social network is disclosed. The potential members of the network are users having mobile devices. Each of the mobile devices has a geographic referencing system. An area is defined by a geo-fence having geographic reference coordinates. It is determined that at least one mobile device is within the area. The mobile device in proximity of the area is contacted with a request to join a social network. The social network includes users having mobile devices, each of whom having checked into the localized social network. A check in to join the social network is received from the at least one mobile device. The user associated with the at least one mobile device is then added to the social network.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

1. Technical Field

The present invention relates generally to a temporary social network, and more particularly, to a social network based in a certain geographical area requiring users to check in to participate.

2. Background

Social networking using the Internet has provided new opportunities for people to meet and establish connections with each other. Typically, a user will create a profile with their interests and other information and create connections with other users on the social network website. However, current social network websites rely on pre-existing recognition of persons to create connections and do not provide the opportunity to meet unknown persons who may share the same interests. For example, in order for a connection to be made, contact must first be made either through other friends or via an actual meeting for information on the social network website relating to a person to be shared with another person. Further, such networks are by their nature independent of a person's location and therefore connections may be made over large geographical distances, but it may be impossible for persons to physically meet.

Traditional social venues such as parties, clubs, or bars where people gather are challenging to make new connections with persons having similar interests or backgrounds since there is no mechanism to survey the persons present in the venue and determine information relating to those present. The present social network websites are of limited use since a person generally cannot access such networks in a social venue. Further such social networks may only make other persons who are already connected with the person aware of their present location. The use of such applications running on mobile devices such as smart phones facilitate this process somewhat, but such present social network applications still require that a person has background information on others to initiate contacts with potential persons of similar interests. Thus such social networking applications have limited utility as a person is generally not aware of potential contacts from the social networking applications in a physical area.

Thus, there is a need for a venue or location specific social network that allows members of such a network to electronically form potential connections with other users in the social network. There is another need for a social network application that allows users to voluntarily join the network by checking in and making themselves known to other members in the network. There is a further need for a social network allowing users to control the information relating to themselves available to other users in the network and have the option for further communications with other users in the network. There is also a need for a venue specific network that allows members to save their contacts made at the venue for a later date.

### SUMMARY

According to one example, a method of creating a localized social network for users associated with mobile devices. Each of the mobile devices has a geographic referencing system. An area defined by a geo-fence having geographic reference coordinates is established. It is determining that at least one mobile device is within the area. The at least one mobile device in proximity of the area is contacted with a request to join a social network of users having mobile devices. Each of the users of the mobile devices is checked in to the localized social network. A check in to join the social network is received from the at least one mobile device. The user associated with the at least one mobile device is added to the social network.

Another example is a system for establishing a social network for a geographical area. The system includes a network interface to establish a geo-fence around an area defined by geographic coordinates. A communications interface determines the presence of mobile devices in the area based on received geographic coordinates from the mobile devices. A controller is operable to send a request to join the network to a mobile device within the area. The controller accepts a check in from a user associated with the mobile device. The controller maintains a social network of all mobile devices which have been checked in and are in the area.

Another example is a mobile device based interface for participating in a social network associated with a geographical area. The social network includes users of mobile devices checked in when the mobile devices are in the area. The mobile device includes a display device and a geographic referencing transceiver to determine the location of the mobile device. The mobile device includes a controller operable to receive information relating to the social network associated with a geographic area when the mobile device is within the area. The controller sends a check in communication to join the social network. The controller receives messages from other mobile devices in the social network. The controller makes identification information associated with the user of the mobile device available to the other members of the social network.

Another example is a non-transitory, machine readable medium having stored thereon instructions for establishing a social network associated with a geographical area. The stored instructions comprise machine executable code, which when executed by at least one machine processor, causes the machine to establish an area defined by a geo-fence having geographic reference coordinates. The instructions cause the machine to determine that at least one mobile device is within the area. The instructions cause the machine to contact the at least one mobile device within the area with a request to join a social network of users having mobile devices within the area. Each of the users of the mobile devices is checked in. The instructions cause the machine to receive a check in communication to join the social network from the at least one mobile device and add a user associated with the at least one mobile device to the social network.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1A is a block diagram of a system that may be used to establish a localized social network and make it available for users of mobile devices;

FIG. 1B is a physical map of a localized social network established by the system in FIG. 1A requiring check in of a mobile device user;

FIG. 2 is a block diagram of an example mobile user device for a person that may participate in the social networks established by the system in FIG. 1A;

FIG. 3A is an image of a welcome screen shown on a mobile user device using the social network application in FIG. 1A;

FIG. 3B is an image of a profile input screen shown on a mobile user device using the social network application in FIG. 1A;

FIG. 3C is an image of a venue listing screen shown on a mobile user device using the social network application in FIG. 1A;

FIG. 3D is an image of the venue listing screen in FIG. 3C when a venue has been selected by the user;

FIG. 4A is an image of a social network information screen shown on a mobile user device using the social network application in FIG. 1A;

FIG. 4B is an image of a news feed posting screen shown on a mobile user device using the social network application in FIG. 1A;

FIG. 4C is an image of a network user summary screen shown on a mobile user device using the social network application in FIG. 1A;

FIG. 5A is an image of a profile screen shown on a mobile user device using the social network application in FIG. 1A;

FIG. 5B is an image of a message screen shown on a mobile user device using the social network application in FIG. 1A;

FIG. 5C is an image of the message screen in FIG. 5B after another member of the social network replies to an initial message;

FIG. 5D is an image of an expanded menu shown on a mobile user device using the social network application in FIG. 1A;

FIG. 6 is a flow diagram of the process used to establish a venue specific social network using the system in FIG. 1A; and

FIG. 7 is a flow diagram of the process used by an application on a mobile user device to join a venue specific social network in FIG. 1A.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

FIG. 1A shows a system 100 for the creation and operation of localized or venue specific social networks. The venue specific social networks created are administered by a localized social network application server 102 that is interfaced with a web server 104 and a social directory application server 106. The web server 104 includes various applications that may be accessed to establish different potential venue based social networks and provide information to potential users. The social directory application server 106 includes information such as user reviews relating to different venues such as restaurants, bars, clubs, and other businesses of interest. An example social directory application is the website Four Square®. The social directory application server 106 also includes geographical data relating to each of the businesses for users of the directory application to find the business and obtain information relating to the business. The server 102 communicates wirelessly through a network 108 to various mobile user devices 110, 112, 114, 116, and 118. The servers 104 and 106 may be in direct communication with the server 102 or they may communicate through the network 108. It is to be understood that two or more computing systems or devices may be substituted for any one of the computing systems or devices in the system 100. Accordingly, principles and advantages of distributed processing, such as redundancy, replication, and the like, also can be implemented, as desired, to increase the robustness and performance of the devices and systems of the system 100.

In this example, the mobile user devices 110, 112, 114, 116, and 118 are generally portable or mobile devices that include geo-referencing hardware and software that allow their location to be known to both their users and the server 102. The geo-referencing hardware and software for locating a particular device in this example is based on the Global Positioning System (GPS), but other geo-referencing systems may be used. As will be explained, the users of the mobile devices 110, 112, 114, 116, and 118 may be members of a conventional social network application administered by a social network server 120. An example of a conventional social network is FACEBOOK®.

The server 102 is also coupled to a database storage server 122. The database storage server 122 includes identification data relating to users and potential users of the social networks created and operated by the server 102. The database storage server 122 also includes data which relates to social networks that are established and made available to various users.

In this example, the location data for a particular user device may be sent via the network 108 to the server 102 for purposes of the social network application described below. In this example, the social network server 102 sets up a temporary localized social network 150 as shown in FIG. 1B for certain user devices in FIG. 1A. FIG. 1B shows a second temporary localized network 152 that may also be established by the server 102. As will be explained below the temporary localized social networks may be set up in physical areas that include clubs, restaurants, bars, and other venues where persons may gather for an event such as a party. It is to be understood that numerous temporary localized networks may be maintained and managed by the social network server 102. The temporary localized network 150 in FIG. 2 includes a geo-fence 160, which encompasses a physical area 162. In this example, the physical area 162 includes the boundary of a building 164 where an event is held. In this example, the geo-fence 160 is established by obtaining the geo-reference coordinates of the building from the social directory server 106 in FIG. 1A and establishing a predetermined radius centered around the coordinates of the building. However, it is to be understood that the shape of the physical area 162 defined by the geo-fence is not bound to any particular geographic shape and may be designed to fit the contours of the physical premises of a space or even part of a building. The geo-fence 160 is composed of coordinate data managed by the server 102, which is defined by the radius in the coordinates associated with the building 164 in this example. Similarly, the social network 152 includes a geo-fence 170 that encompasses a physical area 172. The physical area 172 encompasses the area of another building 174 where a different event is being held. The setup routine for the social network application allows an administrator to define the physical radius and therefore the area 162 bounded by the geo-fence 160 as well as the duration of the social network, which may coincide with the time an event is active, or the hours of business of a restaurant, bar, or club. Of course, the administrator may choose not to limit the duration of the social network by time if desired. Alternatively, the owners of a business may be allowed to adjust the parameters of the social networks localized around their business.

The geo-referencing data from the mobile devices 110, 112, 114, 116, and 118 is periodically compared with the geo-referencing data that defines the boundaries of the geo-fence 160, the geo-fence 170, or other localized social networks maintained by the server 102 to determine whether a user is in sufficient proximity to join the network. Users of mobile devices within proximity of the area 162 bounded by the geo-fence 160 such as the users of the mobile devices 110, 112, 114, and 116 in FIG. 1A are alerted to the social network 150 and may sign in and join the social network 150 in FIG. 1B as will be explained below.

As will be explained below, users that are subscribers to the social network application run by the system 100 may also be made aware of localized social networks that are in proximity of a user device based on the geo-referencing data of the mobile device received by the server 102. For example, the user of the mobile device 118 in FIG. 1B is not within the physical area bounded by either geo-fence 160 or the geo-fence 170 but may be notified via the mobile device 118 of the proximity of the localized social network 150 and the localized social network 152. The user of the mobile device 118 may check into the localized social network 150 or check into the social network 152 since the mobile device 118 is within sufficient proximity of both of the areas 162 and 172.

The mobile user devices 110, 112, 114, 116, and 118 may include virtually any preferably mobile computing device that is configured to send and receive information over a wireless capable network, such as the network 108. In this example, the user devices 110, 112, 114, 116, and 118 are web-enabled and may run browser software for the presentation of web pages to the user. Such user devices 110, 112, 114, 116, and 118 may include portable devices such as cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The user devices 110, 112, 114, 116 and 118 may include multiprocessor systems, microprocessor-based, or programmable consumer electronics, and the like. As such, mobile user devices may range widely in terms of capabilities and features.

As exampled below, the web-enabled user devices 110, 112, 114, 116, and 118 may include a browser application enabled to receive and to send wireless application protocol messages (WAP), and/or wired application messages, and the like. The user devices 110, 112, 114, 116, and 118 also include a social networking application that may be run in conjunction with the browser application. In one example, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information.

The user devices 110, 112, 114, 116, and 118 may also include at least one client application that is configured to receive control data and/or content from another computing device via a network transmission. The client application may include a capability to provide and receive textual content, graphical content, video content, audio content, and the like. Moreover, the user devices 110, 112, 114, 116, and 118 may be further configured to communicate and/or receive a message, such as through a Short Message Service (SMS), direct messaging (e.g., Twitter), e-mail, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between or with another computing device, and the like.

The network 108 is configured to allow communications between one computing device with another computing device. The network 108 may be enabled to employ any form of computer readable media for communicating information from one electronic device to another. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines; full or fractional dedicated digital lines including T1, T2, T3, and T4; Integrated Services Digital Networks (ISDNs); Digital Subscriber Lines (DSLs); wireless links including satellite links; or other communication links known to those of ordinary skill in the art. Furthermore, remote computers and other related electronic devices can be remotely connected to either LANs or WANs via a modem and temporary telephone link.

The network 108 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network 108 may also include an autonomous system of terminals, gateways, routers, and the like connected by wireless radio links or wireless transceivers. These connectors may be configured to move freely and randomly and organize themselves arbitrarily, such that the topology of the network 108 may change rapidly and arbitrarily.

The network 108 may further employ a plurality of access technologies including 2nd (2G), 2.5, 3rd (3G), 4th (4G) generation radio access for cellular systems; WLAN; Wireless Router (WR) mesh; and the like. Access technologies such as 2G, 3G, 4G, and future access networks may enable wide area coverage for mobile devices, such as the user devices 110, 112, 114, 116, and 118, with various degrees of mobility. For example, the network 108 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. The network 108 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the network 108 may include virtually any wired and/or wireless communication mechanisms by which information may travel between one computing device and another computing device, network, and the like.

FIG. 2 is a block diagram of the components of a mobile user device such as the mobile user device 110 in FIG. 1A. The mobile user device 110 includes an application processor 210, a power source 212, a display 214, a baseband processor 216, and a CODEC 218. In this example, the display 214 is an LCD touch screen that allows the user to control the applications run by the application processor 210 via touch inputs as well as view graphics generated by the application processor 210. The display 214 is controlled by a touch screen controller 220. The application processor 210 may be coupled to various devices such as a camera 222 and other interfaces such as a communication port, etc.

The baseband processor 216 receives signals from a network transmitter receiver 230 allowing communications with the network 108 in FIG. 1A and a geo-referencing receiver 232 that allows the reception of positioning data to determine the location of the mobile device 110. The baseband processor 216 processes in the signals and is coupled to the CODEC 218, which converts the signals for use by the application processor 210. The CODEC 218 also decodes audio signals received by a microphone 240 and encodes data signals for output by a speaker 242 for functions such as a telephone application run by the applications processor 210. Of course other audio devices such as a headset may be coupled through the CODEC 218.

The processors 210 and 216 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA), and the like, programmed according to the teachings as described and illustrated herein, as will be appreciated by those skilled in the computer, software, and networking arts.

The operating system software and other applications are stored on read only memory (ROM) 250, random access memory (RAM) 252 and a memory storage device 254 for access by the applications processor 210. In this example, the memory storage device 254 is flash memory, but other memory devices may be used. The applications stored on the memory storage device 254 include the local social network application, which creates interface graphics on the display and interfaces with a browsing application. Of course other forms of applications may incorporate the principles explained below. In this example, the social network application may be preloaded on the mobile user device 110, or may be offered as an application that may be downloaded to the mobile user device 110 from a network device such as the server 102 via the network 108.

The memory storage device 254 includes a machine-readable medium on which is stored one or more sets of instructions (e.g., software) embodying any one or more of the methodologies or functions described herein. The instructions may also reside, completely or at least partially, within memory storage device 254, the ROM 250, the RAM 252, and/or within the processors 210 or 216 during execution thereof by the mobile device 110. The instructions may further be transmitted or received over a network such as the network 108 in FIG. 1A via the network transmitter receiver 230. While the machine-readable medium is shown in an example to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but not be limited to, solid-state memories, optical media, and magnetic media.

A variety of different types of memory storage devices, such as a random access memory (RAM) or a read only memory (ROM) in the system or a floppy disk, hard disk, CD ROM, DVD ROM, flash, or other computer readable medium that is read from and/or written to by a magnetic, optical, or other reading and/or writing system that is coupled to the processor, may be used for the memory or memories in the user device 110.

FIG. 3A shows a welcome screen image 300 shown on the display 214 on a typical user device such as mobile user device 110 in FIG. 2. The welcome screen 300 is displayed by a social network application running on the mobile user device 110. The social network application may interface with the web browsing application executed by the mobile user device 110 or may be separately enabled. In this example, the social network application may be downloaded by the mobile user device 110 from the web server 104 in FIG. 1A. The welcome screen 300 includes a general information field 302, which may include instructions for the social network application that the user may manipulate through the touch screen display 214. The welcome screen 300 in this example has a log in button 304 allowing a user to access a social network application such as the application run by the social network server 120 in FIG. 1A. The social network application in this example is Facebook® but any other type of social media application having access to a database storing user identity information may be used. An account is created for the user by selecting the log in button 304, which stores personal identification information in the database storage server 122 in FIG. 1A. In this example, personal identification information such as name, e-mail, telephone number, and gender is copied from the account associated with the user by selecting the log in button 304. Of course other types of information may be copied from the social network account. Further, a separate interface allowing a user to setup an account to participate in the social networks operated by the server 102 may be used.

FIG. 3B shows an image of a profile input screen 320 shown on the display 214 on a typical mobile user device 110 generated by the social networking application. The data on the profile input screen 320 may be potentially made available to other members of any temporal networks the user of the device decides to check into such as the networks 150 and 152 in FIG. 1B. The profile input screen 320 is identified by a menu bar 322, which includes a control menu button 324 and a done button 326. As will be explained below, the control menu button 324 is a button appearing on most screens of the application that allows a user to overlay a control menu on the screen.

The profile input screen 320 includes a picture area 330, an information field 332, and a control area 334. The picture area 330 includes thumbnail pictures 340 that may be selected for the user profile and eventually made available to other members of the localized social network. In this example, a user may select up to four different pictures to be associated with the user profile. The information field 332 includes various fields including a first name field 342, a last name field 344, a date of birth field 346, a gender field 348, and a smoker indicator field 350. Of course other informational fields such as sexual orientation, likes, and favorites may be added and populated with data either from the user or from an imported profile. The user may edit the text in the various text fields such as the name fields 342 and 344 or the date of birth field 346 via a text entry keyboard available through the touch screen display 214 of the user device 110. The user may also use a toggle control to indicate choices such as the smoker indicator field 350. Of course other information fields may be used and associated with the user profile. In this example, the information for the text fields may be exported from the user's profile associated with a Facebook® account. After the profile is created, the user may finish by selecting the done button 326.

The profile input screen 320 also allows a user to control the types of information and pictures made available to other members of the network via controls in the information control area 334. The information control area 334 allows the user to control the types of information sent with their profile to other members of the network. The information control field 334 in this example includes a birth date toggle switch 352 and a last name toggle switch 354. The user may hide their birth date in the profile display by selecting the toggle switch 352 and hide their last name in the profile display by selecting the toggle switch 354. Other information or settings may also be controlled in the information control area 334. For example, the user may also prevent instant message notification on the mobile user device 110 or block other functions for purposes of running the social network application.

The user may also add pictures for attachment to the thumbnail pictures 340 of the profile input screen 320. The user may take a picture using the camera 222 on the mobile user device 110. The user may also select pictures already stored on the mobile user device 110 for inclusion into the profile. Optionally, the user may be able to load pictures from any accessible memory including those stored on memory devices accessible from the network 108. The user may also access photos associated with other social media accounts via the network 108.

FIG. 3C shows a venue listing screen 370, which is shown after a user completes the profile in the profile input screen 320 in FIG. 3A and thereby establishes an account for the network application operated by the server 102. The venue listing screen 370 includes a number of venue fields 372, 374, 376, and 378 that show available venues and corresponding social networks for a user. As explained above, the available venues and corresponding social network are displayed depending on the proximity of the mobile device 110 to the venue. Each venue field such as the venue field 372 includes the name of the venue and an informational area 380 that shows the contact information such as the physical address of the location of the network as well as the distance from the mobile device 110 to the venue. The data in the informational area 380 may be obtained from the social directory application server 106 in FIG. 1A by the network server 102 and sent to the mobile device 110. The venue field 372 also includes a bubble 382 showing the number of users currently in the social network associated with the venue. The venue field 374 also includes a graphic or picture 384 associated with the venue. Of course other useful information may be displayed in the venue field 374 such as directions, hours, or a menu. The owner of the venue may also provide advertising information to attract the user to select the venue. The venue listing screen 370 may also include a suggest location function that allows a user to search for other venues and create additional social network.

By selecting a venue field such as the venue field 372, the user checks in and joins the social network associated with the venue described by the venue field 372. FIG. 3D shows the venue listing screen 370 after the user has selected one of the venues via the venue fields 372, 374, 376, and 378. In this example, the user has selected the venue represented by the venue field 372. The venue listing screen 370 displays a menu bar 390 that includes the name of the selected venue. The menu bar 390 also includes an exit icon 392 and a location icon 394. When the user selects the exit icon 392, the user leaves the social network associated with the venue. The location icon 394 indicates to the user that they have checked into the social network associated with the venue.

After checking into the social network associated with a venue, FIG. 4A shows a social network information screen 400, which is a summary of the information about the localized social network such as the localized social network 150 in FIG. 1B and the users that have checked in and therefore become members of the localized social network 150. The network screen 400 includes a menu bar 402, a network information field 404, a newsfeed field 406, and a post item bar 408.

The menu bar 402 allows a user to perform various functions. In this example, the menu bar 402 includes a back key 410 and a people icon 412. The back key 410 will return the user to the venue listing screen 370 in FIG. 3C showing nearby venues and corresponding networks. The people icon 412 allows the user to display a screen to show all users within the network the user has checked into as will be explained below.

The network information field 404 displays information about the current social network the user has joined. The information may include a name of the venue 420, a member's icon 422 that displays the number of members in the social network, and a check in icon 424, which indicates that the user has checked in and is therefore a member of the localized social network.

The newsfeed field 406 includes a number of news items 430, 432, and 434 posted by members of the social network the user has joined. The news items such as the news item 432 include an avatar 440 as well as the name of the person 442 who posted the news item and a data field 444 that shows the posted news item. The news items in the newsfeed field 406 are viewable by all of the members of the social network. The news item 430 may also include a time field 446 where the time the item was posted is disclosed. In this example, the data field 444 displays text or photos posted by members of the network over the past two hours. Posted photos are represented by a photo icon 448 that when selected will display the posted photograph on the screen 214. Different durations for keeping news items on the newsfeed field 406 may be used, or all news items posted by members may be displayed without any time limitations during the duration of the social network.

The post newsfeed item bar 408 allows a user to post items to the newsfeed for all of the members of the social network to view. FIG. 4B shows a newsfeed posting screen 460 displayed on the display 214 that is displayed when the post newsfeed item bar 408 is selected. The newsfeed posting screen 460 incorporates the menu bar 402 and the network information field 404 from the information screen 400 in FIG. 4A. The last news item received is displayed such as the news item 434 for user reference.

The posting screen 460 includes a text field 462, a send button 464, and a camera button 466. A text news item may be composed in the text field 462 using a keyboard 468 of the posting screen 460 displayed on the touch screen display 214. The item may be sent to all members of the social network using the send button 464. Alternatively, status buttons or other quick keys such as emoticon icons may be provided to add a shorthand description to the item indicating the user is enjoying the item. The item may also be sent to newsfeeds for other social networks or other social media when the send button 464 is selected. For example, additional interfaces may be provided to automatically post the item to another social network such as Facebook® if a user toggle control is enabled. The item may also be automatically posted to a social feed such as Twitter® if enabled by another toggle control.

The camera button 466 allows a photograph to be submitted as a news item in addition or instead of the text. The camera button 466 may open an interface screen that allows the user to take a picture and post the picture. The interface may also allow the user to select existing photographs stored on the mobile device 110 or access photographs stored elsewhere on any networks the mobile device 110 may be in communication with.

FIG. 4C shows a network user summary screen 470, which is displayed on the mobile device 110 when a user desires to see all individuals in the social network the user is currently a member of. The user summary screen 470 is accessed by selecting the people icon 412 in FIG. 4A. The resulting popup screen 470 overlays the screen 400 in FIG. 4A. A list area 472 includes individual avatar icons 474 that represent all of the members of the social network who have checked in. The individual icons 474 have an associated name field 476 showing the name of the user. The network user summary screen 470 allows the user to select the avatar icon 474 to open up the full individual profile of a user. The order that the members are listed is by the time when each joined the network in this example.

Alternatively, the list of the users may be organized by different criteria in the list area 472 such as alphabetically. The list may also be organized to bring avatars representing persons at the top matching the sexual orientation of the user. The list may also be organized to bring avatars of persons meeting other criteria within the profile data to the top of the list. A summary may also be displayed that includes the number of total members and the members of each sex in the social network or the numbers of members falling under different criteria.

Once an avatar 474 is selected from the network user pop-up screen 470 in FIG. 4C or any avatar associated with a news item in the network information screen 400 in FIG. 4A, a profile screen 500 is displayed on the mobile device 110 as shown in FIG. 5A. The profile screen 500 includes the menu bar 402 and the network information field 404 of the information screen 400 in FIG. 4A as well as a profile field 502 including a selected photo 504 of the user. In this example, the menu bar 402 includes a message icon 501. As explained above, the example social network application allows four photos to be associated with each profile. By touching the main photo 504, the user may scroll through the different photos of the profile such as another photo 506 associated with the profile. Typical touch screen commands may be used for zooms such as pinching and double tapping. The profile field 502 also includes a name field 508 and a birthday field 510, which display the person's name and birthday. As explained above, the user may control the information displayed in the profile field and may limit the name to a first name and not display the birthday depending on the settings in the profile input screen 320 in FIG. 3B.

The profile screen 500 may include other controls relating to the member's profile for additional information. For example, the profile screen 500 may allow a display of common friends according to another social network such as Facebook® they have with other members in the localized social network. The profile screen 500 also allows a user to send a message to the person represented by the profile screen 500 by displaying a message screen 520 in FIG. 5B. The message screen 520 is activated when the user selects the message icon 501 in the menu 402.

In the example social network application, the first two messages sent to another member of the social network via the message screen 520 in FIG. 5B are contact messages. The first two contact messages allow a user to show interest to another member of the social network who may have similar interests or other common background data. The receiving network member may choose to ignore or reply to the contact messages. More messages are allowed to be sent to the member only after reciprocity is achieved, which is defined by at least a single reply to one of the first two contact messages. In this manner, the social network application prevents members against unwelcome messages from other members of the network.

FIG. 5B shows the message screen 520 that is displayed on the mobile user device 110 when a user desires to send a message to the person associated with the profile displayed on the profile screen 500. The message summary screen 520 is specific to the selected user and includes a message area 522 that includes text area 524. The message area 522 includes a touch screen keypad 526 for composing messages. A send button 528 allows a user to send the message. A photo key 530 allows a user to attach a photo to the message. The message summary screen 520 also includes a history area 532 that includes previously sent and received messages such as a message 534. The message 534 includes a text of the message 536 and an information field 538 including the time the message was sent. An avatar 540 of the person associated with the message is included in the message 534. As explained above, only two initial messages may be sent via the message summary screen 520 to a particular member until the recipient acknowledges receipt of the message.

The message screen 520 also includes an alert bar 550 that provides alerts to the user such as indicating that messages are sent or that a person has sent a message. The alert bar 550 may also include information regarding the mode of the message screen, which in this example is in chat mode indicating a private message communication with the selected member. The alert bar 550 includes a close button 552, which closes the message screen 520 and returns the user to the profile screen 500 in FIG. 5A.

FIG. 5C shows the message summary screen 520 after a message is sent by another member. The alert bar 550 now includes a notification that a message has been received from the member. The history area 532 now includes a new message 560 that has just been received. The new message 560 includes the avatar of the sending member and the time the message was sent. The message area 522 remains active for the user to send additional messages to the other member of the social network. As additional messages are sent and received, they are displayed in the history area 532 of the message summary screen 520.

FIG. 5D shows an expanded menu 570 that is displayed by selecting the control menu button 324 on the menu bar 322 in the profile input screen 320 in FIG. 3B or the venue listing screen 370 in FIGS. 3C and 3D. The expanded menu 570 is interposed over the screen and includes a user profile field 572, an available networks field 574, a terms-of-service field 576, a help field 578, a privacy field 580, and a log-out field 582. The user profile field 570 includes a name 590 and the avatar 592 associated with the profile of the user. Selecting the user profile button 572 will access the profile input screen 320 shown in FIG. 3B. Selecting the available networks field 574 will access the venues listing screen 370 shown in FIG. 3C if the user desires to switch venues (social networks). This allows the user to leave the current localized social network such as the network 150 in FIG. 1B and switch to another available network such as the social network 152 in FIG. 1B. In this example, a user must wait a certain period such as half an hour before checking into another network. The terms of service field 574 allows a user to display the terms of service for the application and applicable social networks. The help field 578 allows a user to access help information to operate the application. The privacy field 580 enables a user to display the privacy policy for the application. The log-out field 582 enables a user to log out of the application thereby removing the user from the current social network.

Other functionality may be available on the social network application running on the mobile user device 110. For example, the application may provide an interface to allow the user to invite other friends to join the localized social network. Such an interface may include a display list including avatars of existing friends who are not presently members of the network. The user may invite any individual friend or all friends to join the network via an invite button, which is next to the avatars of individual friends. In this example, another permanent social network application may be used to offer membership in the social network to friends. For example, the user may invite various friends who are members of the Facebook® social network to join the temporary social network such as the network 150 in FIG. 1B. After some or all of the invite controls are selected, the user may send the invitations to the network 150 to those persons invited.

In addition, the mobile device application may also provide additional information gathered by the user. For example, a modified network member summary screen may be displayed that modifies certain avatars representing the persons in the social network by grouping such avatars by common interests with the users. When a user receives a message received notification from a member of the network, the person stays organized in a list of acquaintances. The list of acquaintances includes avatars of persons in the social network that have previously responded to messages and therefore are listed as persons of interest. The user may select the avatars to browse the corresponding profiles and also respond to messages from the persons. Certain of the avatars include a message bubble that indicates how many unread messages have been received by the person. The profile screen allows a user to send a private message via the message summary screen 520 in FIG. 5B to the person that does not show up in the newsfeed interface screen.

Another optional function that may be included in the social network application is a history interface that retains information gathered from other members while the user was a member of a particular social network. The user may then return to the interface after the expiration of the social network to follow up on contacts to members of the social network. Such a summary interface may include lists of avatars that are grouped according to interests, time, number of messages, social networks in common, or other criteria. Each of the avatars in the lists of avatars allows a user to display a profile of the associated person and send messages to that person. As explained above, the social networks established by the system 100 are temporary and have a limited duration. However, a user may retain persons who have common interests when they were members of the network via the history interface for further contact after the network duration has expired. The social network application on the mobile device 110 may retain the chat history for each of the persons and may also be reviewed after the network duration has expired.

A user may always choose to not be notified of a network's activities or choose to leave the network entirely. A user may also be checked out of the party if no activity is detected from the mobile device for a predetermined time such as two hours of no activity. In this example, a user who leaves a network cannot check into another network such as the network 152 in FIG. 1B for a predetermined period of time such as 30 minutes. By checking into a new network, the user automatically signs off from any previous parties.

The operation of the example network system 100 shown in FIG. 1A, which may be controlled on the example server and mobile devices, will now be described with reference to FIGS. 1A and 1B in conjunction with the flow diagrams shown in FIGS. 6 and 7. The flow diagrams in FIGS. 6 and 7 are representative of example machine readable instructions for implementing the interface to establish and operate a temporal, spatially based social network. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 6 may be implemented manually. Further, although the example algorithm is described with reference to the flowcharts illustrated in FIGS. 6 and 7, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 6 is a flow diagram for the process of creation and operation of a localized social network based on the application running on the server 102 in FIG. 1A. The application receives the geographical coordinates from a venue from the social directory application on the server 106 in FIG. 1A (600). The application then establishes a geo-fence such as the geo-fence 160 in FIG. 1B at a predetermined distance using the geographical coordinates of the venue as the center point for a circular area (602). The application then retrieves information and graphics related to the venue from the social directory application server 106 (604). The application then receives geographical coordinates from mobile user devices such as the mobile user devices 110, 112, 114, 116, and 118 in FIG. 1B, when the users of the devices run the social network application on the mobile user devices (606). The application determines which localized social networks are within a predetermined distance of the mobile user device by comparing the geo-fence coordinates with the coordinates sent by the mobile user device (608). The application sends the data (venue information and graphics) relating to the localized networks and associated venues within the predetermined distance for display on the mobile user device (610). The application receives a check in from the user of the mobile user device (612). The application then adds the user and associated profile to the social network associated with the venue to the associated database 104 (614). The application then makes available new feeds and profiles of other members of the social network to the user (616).

FIG. 7 is a flow diagram of the process of communication with the social network based on the social network application run on the mobile device 110 in FIGS. 1A and 2. As explained above, the mobile device application may be loaded on the mobile device 110 via the network 108. Once the application is activated, it obtains the geographical coordinates of the mobile device 110 from the geo-referencing transceiver 230 in FIG. 2 and sends the coordinates of the mobile device 100 to the server 102 (700). The mobile device application then displays the profile input screen 320 in FIG. 3B to the user to create a profile or download a profile from another social network (702). Once the profile is completed, the application on the server 102 creates an account for the user and stores the account in the database 104. Of course if an existing account already exists, the application may omit the process of creating a profile. The mobile device application then receives a list of the available localized social networks from the server 102 and displays the available social networks on the venue listing screen 370 in FIG. 3B (704). The application receives a selection from the user and sends a check in communication to the server 102 for the user for the selected localized social network (706).

After the user is checked into a localized social network, the mobile application receives member information of other users in the localized social network (708). The information relating to other members of the social network may be displayed in the network user screen 470 in FIG. 4C by the application. The application also obtains a real time feed of news items submitted by members of the social network for display on the newsfeed field 406 in FIG. 4A (710).

The social network application in FIGS. 1A and 1B provides a social network option for persons within the same geographic area attending an event. This provides persons with additional information to contact other persons at the same event with similar interests. The persons allow how much information about themselves to be sent to other members of the social network.

Each of these embodiments and obvious variations thereof is contemplated as falling within the spirit and scope of the claimed invention, which is set forth in the following claims.

What is claimed is:

1. A method of creating a localized social network for users associated with mobile devices, each of the mobile devices having a geographic referencing system, the method comprising:
establishing an area defined by a geo-fence having geographic reference coordinates;
determining that at least one mobile device is within the area;
contacting the at least one mobile device in proximity of the area with a request to join a social network of users having mobile devices, each of the users of the mobile devices being checked in to the localized social network;
receiving a check in to join the social network from the at least one mobile device; and
adding the user associated with the at least one mobile device to the social network.

2. The method of claim 1, further comprising allowing the user of the at least one mobile device to establish a profile including the identification information.

3. The method of claim 1, further comprising listing the localized social network and a second localized social network area defined by a geo-fence in proximity to the at least one mobile device, wherein the contacting includes a request to join a second localized social network of users having mobile devices.

4. The method of claim 1, further comprising displaying a newsfeed specific to the social network to the user, wherein the newsfeed includes items sent by other users of the social network.

5. The method of claim 1, wherein a profile of all users of the social network may be displayed on the mobile device.

6. The method of claim 1, wherein individual messages may be sent to another mobile device in the localized social network if a predetermined criteria is met.

7. The method of claim 1, wherein the social network has a limited duration time for checking in users of mobile devices within the area.

8. The method of claim 7, wherein a history of messages is displayed with messages from interaction with other users after the duration time has expired.

9. The method of claim 1, further comprising removing the user of the mobile device from the localized social network if no activity has occurred over a predetermined period of time.

10. The method of claim 1, further comprising displaying a user control on the mobile device to allow the user to select the types of identification information shared with other users of mobile devices in the social network

11. A system for establishing a social network for a geographical area, the system comprising:
a network interface to establish a geo-fence around an area defined by geographic coordinates;
a communications interface to determine the presence of mobile devices in the area based on received geographic coordinates from the mobile devices;
a controller operable to:
send a request to join the social network to a mobile device within the area;
accept a check in from a user associated with the mobile device; and
maintain a social network of all mobile devices which have been checked in and are in the area.

12. The system of claim 11, wherein the mobile device allows a user to establish a profile including identification information associated with the user.

13. The system of claim 11, wherein the controller sends a listing the social network and a second social network area defined by a geo-fence in proximity to the mobile device, wherein the controller further sends a request to join a second social network of users having mobile devices.

14. The system of claim 11, wherein the mobile device displays a newsfeed specific to the social network to a user, wherein the newsfeed includes items sent by other users of the social network.

15. The system of claim 11, wherein a profile of all users of the social network may be displayed on the mobile device.

16. The system of claim 11, wherein individual messages may be sent to another mobile device in the social network from the mobile device if a predetermined criteria is met.

17. The system, of claim 11, wherein the social network has a limited duration time for checking in users of mobile devices within the area.

18. The system of claim 17, wherein a history of messages is stored and the mobile device displays messages from interaction with other users after the duration time has expired.

19. The system of claim 11, wherein the controller removes the user of the mobile device from the social network if no activity has occurred over a predetermined period of time.

20. A mobile device based interface for participating in a social network associated with a geographical area, the social network including users of mobile devices checked in when the mobile devices are in the area, the mobile device comprising:
a display device;
a geographic referencing transceiver to determine the location of the mobile device; and
a controller operable to:
receive information relating to the social network associated with a geographic area when the mobile device is with in the area;
send a check in communication to join the social network;
receive messages from other mobile devices in the social network; and
make identification information associated with the user of the mobile device in the social network available to the other members of the social network.

21. A non-transitory, machine readable medium having stored thereon instructions for establishing a social network associated with a geographical area, the stored instructions comprising machine executable code, which when executed by at least one machine processor, causes the machine to:
establish an area defined by a geo-fence having geographic reference coordinates;
determine that at least one mobile device is within the area;
contact the at least one mobile device within the area with a request to join a social network of users having mobile devices within the area, each of the users of the mobile devices being checked in;
receive a check in communication to join the social network from the at least one mobile device; and
add a user associated with the at least one mobile device to the social network.
